(19) United States
(12) Patent Application Publication
(10) Pub. No.: US 2007/0208653 A1
(43) Pub. Date: Sep. 6, 2007

(54) FACILITATED ACCELERATION OF INFORMATION REVELATION

(76) Inventor: Jeremy Murphy, Oak Park, CA (US)

Correspondence Address: STRATEGIC PATENTS P.C.., C/O PORTFOLIOIP, P.O. BOX 52050, MINNEAPOLIS, MN, 55402, US

(21) Appl. No.: 11/679,156

(22) Filed: Feb. 26, 2007

Related U.S. Application Data
(60) Provisional application No. 60/779,468, filed on Mar. 5, 2006.

(51) Int. Cl. G06Q 40/00

(52) U.S. Cl. 705/37

(57) ABSTRACT

Through a variety of market or quasi-market techniques, internal corporate information can be conveyed to external markets in a manner that reflects knowledge, opinions, predictions, and the like of corporate personnel without requiring disclosure of specific insider or other confidential corporate information. The market techniques may include highly concrete mechanisms such as explicit executive selection or trading of elements of a compensation package based on, e.g., various measures of corporate, group, or personal performance. More abstract mechanisms such as polling or voting may also be employed to measure and quantify internal company views. The resulting data may also be conveyed to external markets in a variety of ways ranging from real time or near-real time data feeds to periodic, aggregate reporting.

### RELATED APPLICATIONS

This application claims the benefit of U.S. Provisional Patent Application No. 60/779,468 filed on Mar. 5, 2006, the entire content of which is incorporated herein by reference.

### BACKGROUND

1. Field

The invention relates to executive compensation in efficient markets, and more particularly to providing systems and/or methods of compensation that communicate information to external markets.

2. Description of Related Art

Corporations employ several methods of communicating information, some of which are entirely voluntary, but none of which succeeds at inducing insiders to provide immediate, accurate, comprehensive communications that even unsophisticated investors, outside investors, creditors and the like can understand. The current methods include financial statements, quarterly conference calls, earnings guidance and direct disclosures.

The most glaring deficiency of financial statements is that they are backward looking and prepared infrequently—weeks or months after operating results and financial positions are apparent to certain insiders. Moreover, although legal penalties encourage certain insiders to ensure that financial statements are technically accurate, nothing encourages those insiders to ensure that financial statements are wholly intelligible to unsophisticated investors, outside investors, creditors and the like.

Earnings and other forms of guidance, though a useful complement to financial statements, also suffer several shortcomings. Because guidance requires a meeting of the minds, it cannot be given continuously in “real time” as new information arises. Moreover, in forcing a corporation to speak with one voice, guidance leaves no room for dissenting opinions and weakens individual accountability for the accuracy of the guidance. Finally, guidance often looks ahead only one quarter and, as such, overlooks information that will not immediately impact a business's operating results.

Examples of direct disclosures are press releases and analyst calls. The first problem with direct disclosures is that some information cannot be directly disclosed without destroying its value. To divulge details of promising technologies or business practices that are under development is to invite unwanted competition, but to omit the details is to strip the disclosure of credibility. Additionally, the direct disclosures that fill analyst calls are often so esoteric that they solidify rather than mitigate the informational disadvantage of unsophisticated investors, outside investors, creditors and the like.

There remains a need for improved techniques for conveying corporate information to external markets such as public equities markets.

### SUMMARY

Through a variety of market or quasi-market techniques, internal corporate information can be conveyed to external markets in a manner that reflects knowledge, opinions, predictions, and the like of corporate personnel without requiring disclosure of specific insider or other confidential corporate information. The market techniques may include highly concrete mechanisms such as explicit executive selection or trading of elements of a compensation package based on, e.g., various measures of corporate, group, or personal performance. More abstract mechanisms such as polling or voting may also be employed to measure and quantify internal company views. The resulting data may also be conveyed to external markets in a variety of ways ranging from real time or near-real time data feeds to periodic, aggregate reporting.

Disclosed herein are systems and/or methods for creating, providing, administering and/or maintaining a form of compensation that allow each participating insider (or group of insiders), such as an executive, researcher, manager, product team leader and the like, to modify his (or the group's) compensation, such as executive compensation, in light of his (or the group's) information concerning corporate circumstances, results (particularly non-public results), expectations, and so forth. The modifications may involve trading, wagering, making predictions, and/or selecting compensation, as well as other behavior. The modifications may function as signals related to one or more securities, commodities, currencies, derivative claims (including futures and options), indices, funds, performance metrics, operating results, financial positions, financing events, takeovers, mergers, acquisitions, business conditions, business decisions, forecasts or the like. The modifications may be at fixed intervals or on a continuous basis. The modifications may be unilateral, bilateral and/or multilateral. The actions may take place in a market or the like. The modifications may be combined, considered and/or weighted with other factors in order to determine each insider's compensation. The combination, consideration and/or weighting may be done objectively, for example, by using a formula, rules, or the like, or subjectively, for example, by deliberation among the board of directors or the like. The compensation may be performance based-compensation. The modifications may have an indirect and/or delayed effect on compensation. In an embodiment, an insider may demonstrate his ability to accurately predict future share prices without being directly compensated for his predictions; rather, the demonstrated accuracy of his predictions may allow him to negotiate greater compensation in a future employment contract. In this way, through his predictions he is indirectly modifying his future compensation and contributing to his human capital. The systems and/or methods may be embodied in a facilitated acceleration of information revelation (“FAIR”) facility.

The invention may include systems and/or methods for creating, providing, administering and/or maintaining one or more markets or the like in which an insider (or group of insiders) modifies his (or the group's) compensation. Such a market may include an exchange, automated quotation system, order matching system, auction system, clearinghouse or the like. Participation in such a market may be restricted to certain employees, corporate entities, insiders or others. Such a market may include phantom securities. Such a market may be part of a FAIR facility.

The invention may include systems and/or methods for linking modifications or other communications made by insiders to interested parties. The linking may involve systems and/or methods for facilitating, recording, transmitting, publishing, publicizing, filtering, displaying and/or organizing modifications or other communications made by insiders. The linking may be accomplished via a FAIR facility.

The invention may include systems and/or methods for creating, providing, administering and maintaining communications to insiders from interested parties. The communications may be at fixed intervals or on a continuous basis. The systems and/or methods may be embodied in a FAIR facility.

The invention may include systems and/or methods for linking the communications from interested parties to insiders. The linking may involve systems and/or methods for facilitating, recording, transmitting, publishing, publicizing, filtering, displaying and/or organizing those communications. The linking may be accomplished via a FAIR facility. The FAIR facility may permit or facilitate direct or indirect two-way communication between insiders and interested parties.

The invention may include systems and/or methods for analyzing modifications or other communications made by or to insiders. This may include analyzing the actions and/or inactions of insiders. In an embodiment, if an insider declines to make a trade in phantom securities when a trade in phantom securities is offered to him, that inaction may contain information that can be revealed through analysis of his previous actions and inactions. The analysis may include statistical, mathematical, technical, graphical and/or descriptive analysis, or the like. The analysis may be real-time analysis. The analysis may be accomplished via a FAIR facility. The analysis may be a truncated or minimal analysis, merely summarizing the action or inaction.

The invention may include systems and/or methods for linking the analysis to interested parties. The linking may involve systems and/or methods for facilitating, recording, transmitting, publishing, publicizing, filtering, displaying, and/or organizing that analysis. The linking may be accomplished via a FAIR facility.

The term “information” as used herein is intended to refer to all information relevant to the value of a business or organization (such as a corporation) or relevant to the value of one or more securities, commodities, currencies, derivative claims (including futures and options), indices, funds, bonds or other debt instruments, or the like. Information may include information about the business, financials, prospects, inside information, results, research results, experimental result, survey data, feelings, predictions, forecasts, decisions, future transactions, past, present and/or future performance, and the like. Information may be objective or subjective, and may include, for example, individual or aggregate opinions within a company concerning general or specific prospects for the company's future. Thus, by way of example and not of limitation, information may include a particular executive's opinion concerning the upcoming fiscal year, an engineering or scientific research team's view on various research and development initiatives, or the management team's aggregate knowledge about current financial performance that has not yet been communicated to the general public. Information may involve knowledge or expectations. Information may relate to the past, present or future. Information may relate to business affairs, business conditions, plans, opportunities, litigation, finances, profitability, growth, market-share, prices, volumes, suppliers, vendors, customers, competitors, regulators, employees, contractors, consultants, sales, sales prospects, customer defaults, order cancellations, inventories, industry metrics, or the like. Information may relate to products, services, technical data, know-how, ideas, inventions, concepts, software, equipment, designs, drawings, specifications, techniques, processes, models, data, source code, object code, documentation, diagrams, flow charts, research and development, or the like, including the marketability of the foregoing. Information may also relate to financing events, takeovers, mergers, acquisitions, supply, demand, stock issues, stock buybacks, stock-based employee or executive compensation or other conditions in the debt, equity, commodities, currencies, futures or derivatives markets. Information may relate to economic growth, productivity, employment, inflation, taxes, spending, current account deficits, or the like.

The term “phantom security” (also referred to herein as a “synthetic security”) is intended to refer to an interest traded in a FAIR trading environment. This may include one or more rights, options, obligations, contracts or the like, the values of which are based on or affected by one or more parameters (such as price, volatility, volume, timing, or an analyst expectation) related to one or more securities, commodities, currencies, derivative claims (including futures and options), indices, funds, performance metrics, operating results, financial positions, financing events, takeovers, mergers, acquisitions, business conditions, business decisions, forecasts or the like. The value of a phantom security may be also be affected by supply and demand within a market or the like for phantom securities. The value of a phantom security may also be affected by a board of directors or the like. The value of a phantom security may be measured in dollars, points or other units. The value of a phantom security may be determined objectively or subjectively. In various embodiments described herein, company employees, executives, officers, and/or directors may actually trade phantom securities to directly control factors in their compensation, so that the phantom security operates as a derivative financial instrument traded within a company. In other embodiments the phantom securities may reflect other compensation decisions, but nonetheless be communicated to external markets as a signal for inside information.

In general, the term “insider” refers to any individual having access to and/or possession of inside information about a company including, for example a director, officer, executive, employee, contractor, consultant, advisor, lawyer, banker, investment banker, creditor, debtor, securities exchange, association, regulator, government official, government body, corporation, affiliate, researcher, media outlet, or other individual or group with general or role-specific access and/or possession of inside information. Other individuals such as brokers, analysts and other nominal outsiders may periodically possess inside information, although under present securities laws any such disclosure by the company must also be publicly disclosed. In certain instances a device or system may contain inside information, such as a computer program, computer network, computer database, automated quotation system, or the like, in which case the system or device may be considered an insider as that term is used herein. Unless a specific meaning is provided or otherwise clear from the context, all of the above entities may be considered to be “insiders” as that term is used herein.

The term “interested party” is intended to refer to a director, officer, executive, employee, contractor, consultant, advisor, lawyer, banker, broker, dealer, regulator, government official, government body, investor, creditor, debtor, analyst, corporation, affiliate, researcher, stock exchange, association, automated quotation system, media outlet, computer program, computer network, computer database, or any other person, device, system, institution or entity that may access communications from insiders, access analysis of insiders' communications, send communications to insiders or receive information. An insider may be an interested party. The general public or a public market may be an interested party. Throughout this disclosure the term investor may include any direct or indirect stakeholder or any party who may be affected by the information.

### BRIEF DESCRIPTION OF THE FIGURES

The invention will be more fully understood by reference to the detailed description, in conjunction with the following figures, wherein:

FIG. 1 depicts interactions among an insider, interested parties and a FAIR facility.

FIG. 2 depicts a particular embodiment of interactions among an insider, interested party and a FAIR facility.

FIG. 3A depicts a situation in which the marginal price of phantom shares is less than the expected liquidation price.

FIG. 3B depicts a situation in which the marginal price of phantom shares equals the expected liquidation price.

FIG. 3C depicts a situation in which the marginal price of phantom shares is greater than the expected liquidation price.

FIG. 4 depicts the effects of uncertainty in relation to trading behavior.

FIG. 5 shows a FAIR system.

### DETAILED DESCRIPTION

When a business is owned entirely by insiders and has liabilities only to insiders, all information that is known by the business's insiders is also known by its investors, since they are the same people. When, however, a business is owned partly or entirely by outsiders (such as passive investors or, where the company is publicly traded, the general public, investment firms, hedge funds, and so forth) or has liabilities to outsiders, insiders may possess information that these outside investors do not. The inability of outside investors to acquire the information of insiders at zero cost is a fundamental inefficiency of the public corporation. Other businesses and organizations (including government bodies) may also benefit from increased transparency.

In general, a Facilitated Acceleration of Information Revelation (“FAIR”) facility 108, as described herein, may be usefully employed to communicate inside information from insiders 102 to interested parties 104 without requiring disclosure of the inside information. As depicted, insiders 102 may communicate with the FAIR facility, such as providing opinions, predictions, and/or selections of compensation structure. The FAIR facility 108 may, in turn, communicate the results of insider-FAIR communications to interested parties 104. Of course, insiders 102 may continue to communicate with interested parties 104 in any suitable form. However, where insiders 102 possess inside or confidential information, this may be communicated to interested parties 104 indirectly through the manifestation of this information in the insider's input to the FAIR facility 108.

The less information investors have at any moment or over any period of time, the less certain they are at that moment or over that period of time about the future returns of their securities and/or investments. Uncertainty about future returns may be undesirable for several reasons. Investors may prefer certain returns to uncertain returns and are thus harmed by uncertainty per se. Some market participants may waste resources acquiring information in order to benefit from trades with others. Some market participants, including market makers, may respond to better informed market participants by altering their own trading behavior in ways that impair the market.

Disclosed herein are systems and/or methods for creating, providing, administering and/or maintaining a form of compensation that allows each participating insider (or group of insiders) to modify his (or the group's) compensation, such as executive compensation, in light of his (or the group's) information. The insider may, of course, rely in whole or in part on publicly available information. However, as a significant advantage over existing systems for disseminating corporate information, the insider may also, or instead, rely on non-public information in selecting compensation options, thereby communicating the insider's expected value of the non-public information to the public without requiring release of the information to the public. The choices made by the insider may more generally involve trading, wagering, making predictions and/or selecting compensation, as well as other behavior. The modifications may function as predictions or signals about one or more investments, securities, commodities, currencies, derivative claims (including futures and options), indices, funds, performance metrics, operating results, financial positions, financing events, takeovers, mergers, acquisitions, business conditions, business decisions, forecasts or the like. While the following description focuses on securities, it will be readily appreciated that the systems and methods described herein may apply equally to pricing for new bond issues, existing bond issues, credit ratings, expectations of delinquency, and other debt-related instruments and/or metrics. The modifications may be at fixed intervals or may be continuous, intermittent, or on any other scheduled, ad hoc, or other basis. In general, references to a fixed interval or continuous basis will be understood to refer to any periodic, aperiodic, scheduled, event-driven, ad hoc, or other time basis for the occurrence of corresponding events. The modifications may be unilateral, bilateral or multilateral. The modifications may be in a market (such as a trading environment supported by a FAIR facility) or the like. The modifications may be combined, considered and/or weighted with other factors in order to determine each insider's compensation. The other factors may include financial metrics for either the insider's division (or other area of responsibility) or the entire company, such as sales, costs, profitability, earnings, return on investment, growth rates, relative performance in an industry, and the like. The other factors may include other quantitative metrics such as peer evaluation scores, employee evaluation scores, or the like. The other factors may also account for the impact of the decisions made by the insider, contributions to the overall business, or other measures of leadership and management ability. The combination, consideration and/or weighting may be done objectively, for example, by using a formula, rules, or the like, or subjectively, for example, by deliberation among the board of directors or the like. The subjective considerations may provide a subjective filter, which may act as a check on whether an insider is acting in the interests of all or certain constituents, such as shareholders. The subjective considerations may prevent abuse or reduce or eliminate the perception of potential abuse by insiders. The compensation may be performance based-compensation. An insider (or group of insiders) may be compensated for the speed of his (or the group's) modifications, for the accuracy of the signals expressed by his (or the group's) modifications, for other criteria related to his (or the group's) modifications, and/or for participating in a broader arrangement that allows for such modifications. Additionally or alternatively, the modifications may have an indirect and/or delayed effect on compensation. In an embodiment, an insider may demonstrate his ability to accurately predict future share prices without being directly compensated for his predictions; rather, the demonstrated accuracy of his predictions may allow him to negotiate greater compensation in a future employment contract. In this way, through his predictions he is indirectly modifying his future compensation and contributing to his human capital. The systems and/or methods may be embodied in a FAIR facility.

Disclosed herein are systems and/or methods for creating, providing, administering and/or maintaining one or more markets or the like in which an insider (or group of insiders) may modify his (or the group's) compensation. Such a market may include an exchange, automated quotations system, order matching system, auction system, clearinghouse or the like. Participation in such a market may be restricted to certain employees, corporate entities, insiders, or others. Such a market may include phantom securities. Such a market may be part of a FAIR facility.

The value of a phantom security may be based on or affected by one or more parameters (such as price, volatility, volume, timing, or an analyst expectation) related to one or more securities, commodities, currencies, derivative claims (including futures and options), indices, funds, performance metrics, operating results, financial positions, financing events, takeovers, mergers, acquisitions, business conditions, business decisions, forecasts or the like. The value of a phantom security may also be affected by supply and demand within a market for phantom securities. The value of a phantom security may also be affected by a board of directors or the like. The value of a phantom security may be measured in points or other non-monetary units. The points or other units may be combined, considered and/or weighted with other factors in order to determine each insider's compensation. In one aspect, the market for phantom securities would not be open to the general public, and may not necessarily be subject to securities laws and related regulations.

In another aspect, disclosed herein are systems and/or methods for linking modifications or other communications made by insiders to interested parties, such as the investing public. The linking may involve systems and/or methods for facilitating, recording, transmitting, publishing, publicizing, filtering, displaying and/or organizing the modifications or other communications made by insiders. The linking may be accomplished via a FAIR facility.

In another aspect, disclosed herein are systems and/or methods for creating, providing, administering and/or maintaining communications to insiders from interested parties. The communications may be at fixed intervals or on a continuous basis. The systems and/or methods may be embodied in a FAIR facility.

Disclosed herein are systems and/or methods for linking the communications from interested parties to insiders. The linking may involve systems and/or methods for facilitating, recording, transmitting, publishing, publicizing, filtering, displaying and/or organizing the communications. The linking may be accomplished via a FAIR facility.

Disclosed herein are systems and/or methods for analyzing the modifications or other communications made by or to insiders. This may include analyzing the actions and/or inactions of insiders. In an embodiment, if an insider declines to make a trade in phantom securities when a trade in phantom securities is offered to him, that inaction may contain information that can be revealed through analysis of his previous actions and inactions. The analysis may include statistical, mathematical, technical, graphical and/or descriptive analysis, or the like. The analysis may be real-time analysis. The analysis may be accomplished via a FAIR facility. The analysis may be a truncated or minimal analysis, merely summarizing the action or inaction.

The invention may include systems and/or methods for linking the analysis to interested parties. The linking may involve systems and/or methods for facilitating, recording, transmitting, publishing, publicizing, filtering, displaying, and/or organizing that analysis. The linking may be accomplished via a FAIR facility.

In embodiments, a FAIR facility may allow each insider (or group of insiders) to unilaterally or otherwise alter certain determinants of his (or the group's) performance-based or other compensation by trading phantom securities. In one embodiment, an executive may trade phantom securities with his employer, subject to previously agreed-upon rules, in a market, such as a restricted-access market. In one embodiment, the value of a phantom security may be based on the price of a publicly traded share of common and/or preferred stock. In one embodiment, an insider may freely trade the phantom security (even where the insider is prohibited from trading the publicly traded security) and these trades may be available for inspection by the general public. In another embodiment, the phantom security may represent a corporate metric such as monthly, quarterly, or annual profit of the company, or of a division within the company, and an executive or other employee may choose to have compensation based on that metric in proportion to the quantity of phantom securities owned. As with a phantom security that tracks stock price, trades in the metric-based phantom security may be available for public inspection through the FAIR facility.

In embodiments, the purchase price of a phantom security may change at the margin in a predetermined fashion. Gradual escalation of the marginal price of a phantom security may be useful in order to induce each insider to buy a phantom security until the price of that phantom security equals his perception of the true value of the parameter (or parameters) that forms the basis for the price of the phantom security.

In embodiments, phantom securities may liquidate automatically on a predetermined date at the public market price on that date, similar to the expiration of a futures or options contract. In embodiments, insiders may be allowed to liquidate their phantom securities at a time of their choosing, similar to the sale of a stock. Liquidations may be announced or otherwise communicated to interested parties at the time of the liquidation.

In embodiments, phantom securities may be traded between insiders. In embodiments, phantom securities may be traded between insiders and their employers or organizations to which they belong. In embodiments, phantom securities may be traded between insiders and specialists or dealers.

In embodiments, trades involving phantom securities may be for immediate cash settlement or on other settlement terms. In embodiments, as an alternative to cash settlement, a FAIR facility may allow an insider to trade phantom securities for points, other phantom securities or other non-monetary consideration. A FAIR facility may allow an insider to trade points or other consideration directly.

The systems and/or methods described herein may be created, provided, administered, and/or maintained entirely within each corporation or on a central basis. One firm may provide the methods and/or systems for others.

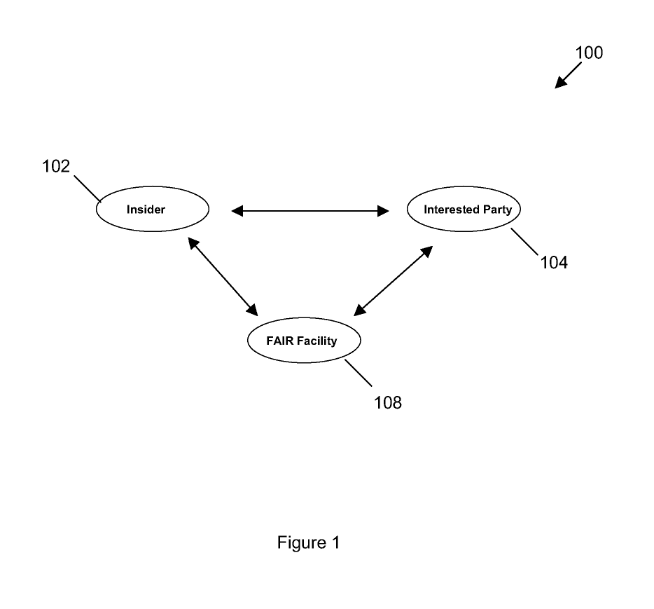

Referring to FIG. 1, insiders 102 may interact with interested parties 104 via a FAIR facility 108. Insiders 102 may also interact directly with interested parties 104, although certain arrangements between an insider 102 and his employer may prevent or limit such interactions. The insider 102 may be a director, officer, executive, employee, contractor, consultant, advisor, lawyer, banker, broker, dealer, analyst, investor, creditor, securities exchange, association, automated quotation system, regulator, government official, government body, corporation, affiliate, researcher, media outlet, computer program, computer network, computer database, or any other person, device, system, institution or entity possessing information. A FAIR facility 108 may include technicians, traders, analysts, supervisors, computing devices, websites, networks, software, rules, regulations, policies, contracts, or the like. An interested party 104 may be a director, officer, executive, employee, contractor, consultant, advisor, lawyer, banker, broker, dealer, regulator, government official, government body, investor, creditor, analyst, corporation, affiliate, researcher, stock exchange, association, automated quotation system, media outlet, computer program, computer network, computer database, or any other person, device, system, institution or entity that may access communications from insiders, access analysis of insiders' communications, and/or send communications to insiders. An insider may be an interested party. The general public or a public market may be an interested party.

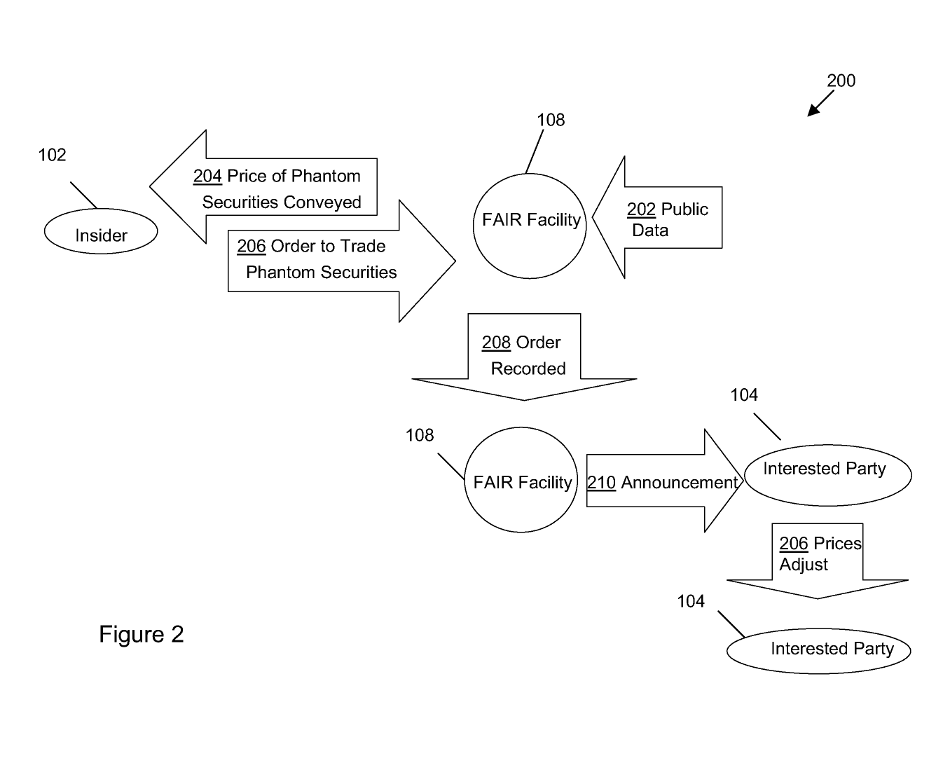

FIG. 2 is a high-level depiction of a FAIR process 200. In step 202 the price of a phantom security may be linked to a parameter, such as the public market price of a share of common stock. In step 204 the public market price may be recorded and the price of the phantom security may be calculated based on a predetermined formula and conveyed to the insider 102. In step 206 the insider 102 may place an order to trade phantom securities (such as a purchase or sell order). In step 208 details of the trade, which may include the quantity and price of phantom securities traded, may be recorded in order to calculate the necessary payment to or from the insider 102 or to adjust the insider's compensation. In step 210 those details may be announced or otherwise communicated to interested parties 104, such as the public market. In step 206 the prices, such as public market prices, may adjust to the announcement or other communication of the details.

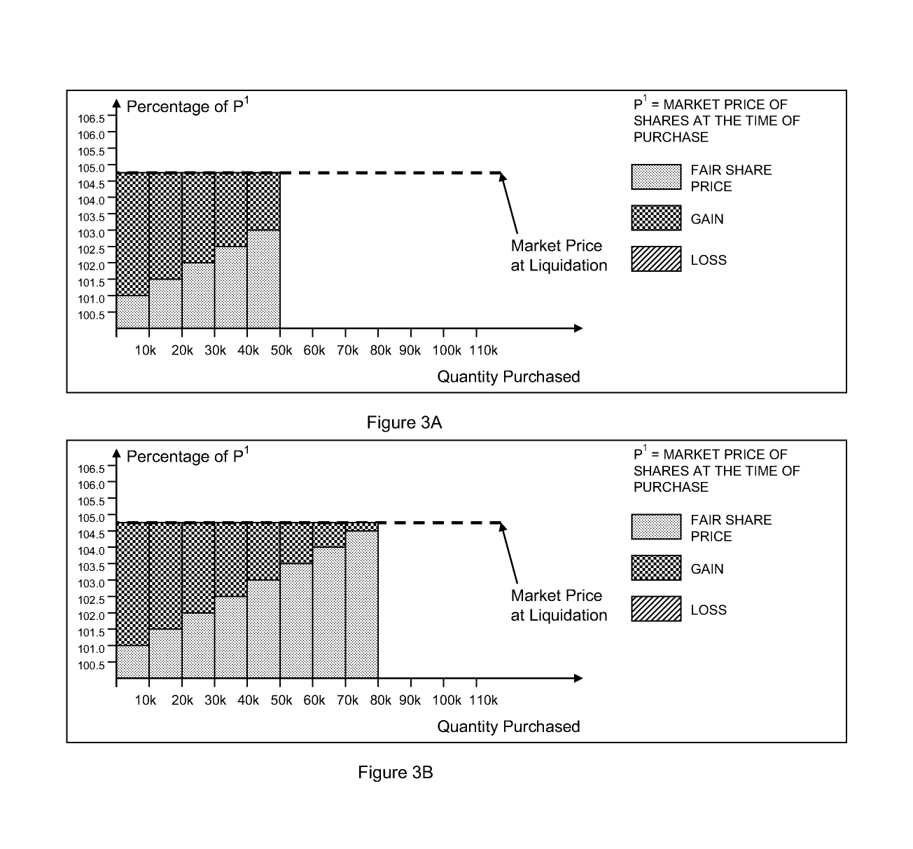

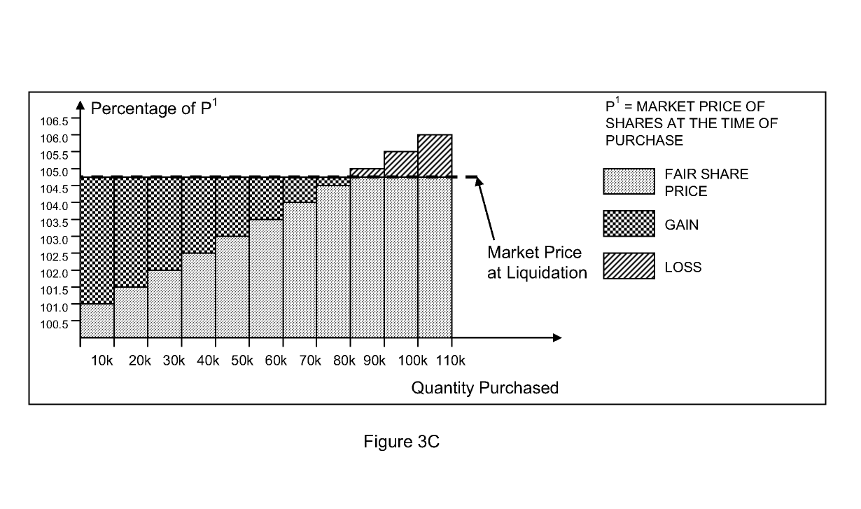

Referring to FIG. 3, if an insider can liquidate phantom shares at the level of a parameter, such as the public market price of a share of common stock, that prevails at the time of the liquidation, then in order to maximize his expected profits, an insider 102 may stop purchasing phantom shares when the marginal purchase price of a phantom share equals the level of the parameter that he expects to prevail when he liquidates the phantom shares. FIG. 3B shows the situation in which the marginal price of a phantom share equals the public market price that the insider 102 expects to prevail when he liquidates. FIG. 3A shows that purchasing fewer shares may leave profits on the table and FIG. 3C shows that purchasing more shares may result in losses on the last shares purchased.

In embodiments, the price of a phantom security may be adjusted according to the size or timing of purchases. For example, a corporation may allow an insider 102 to buy a certain class of phantom shares (referred to below as “Fshares”) at a price that starts at the current public market price of the corporation's common stock and that ascends at the margin according to the following schedule: an insider 102 can add 10,000 Fshares to his account, with each Fshare costing 101% of the market share price that prevails the instant he places his order; he can add 20,000 Fshares to his account—the first 10,000 each costing 101% of the market share price that prevails the instant he places his order, the second 10,000 each costing 101.5% of the market share price that prevails the instant he places his order; he can add 30,000 Fshares to his account—the first 10,000 each costing 101.0% of the market share price that prevails the instant he places his order, the second 10,000 each costing 101.5% of the market share price that prevails the instant he places his order, the third 10,000 each costing 102.0% of the market share price that prevails the instant he places his order; and so on. Purchases of Fshares may be announced or otherwise communicated to the market immediately or with a specified delay. The announcement or other communication may include the name of the purchaser, his affiliation with the company, his position, his tenure with the company, his ownership of securities or derivative securities in the company or other companies, the dollar value of Fshares purchased, the marginal price at which he stopped purchasing and/or analysis related to his current or historical purchases, such as correlations between his prior purchases and movements in share price. For example, an announcement may read, “Jeremy Murphy, Chief Financial Officer of Murphy Corp., purchases $1,000,000 of Fshares up to a final marginal price of $82.” Immediately, or after a specified delay, the insider 102 may be allowed to transact further in Fshares. Establishing a negative balance (“short”) of Fshares may be the mirror image of establishing a positive balance: incremental prices may move down instead of up, those prices may be paid to an insider 102 in the form of cash, points or other consideration, and the market price of shares at the time of liquidation may be paid by the insider 102 in the form of cash, points or other consideration. The liquidation of a position in Fshares may be announced when it occurs or with a specified delay. In this general manner, a premium may be approximately determined based on the anticipated effect of the insider's purchase on the public markets.

Similarly, trading in Fshares may be regulated or limited in a number of other ways. For example, a particular user may be limited to certain percentage allocations of particular types of Fshares. Thus an executive may have a maximum of 20% of compensation tied to performance of divisions that the executive is not associated with. Any number of similar limits may be implemented including caps related to public stock price, earnings, sales, and so forth. The system may also, or instead, limit a volume of total transactions, or a volume of a particular type of transaction on a time basis. These limitations may vary according to position within the company hierarchy according to, e.g., management level, years with company, management responsibilities (engineering, accounting, marketing, etc.), and so forth.

In embodiments, insiders 102 may trade units of one form of compensation for units of another form of compensation. In one embodiment, insiders 102 may trade units that vary positively with earnings per share for fixed units of compensation. The units of compensation, as well as the rates at which the units may be traded for one and other, may be affected by one or more parameters (such as price, volatility, volume, timing, or an analyst expectation) related to one or more securities, commodities, currencies, derivative claims (including futures and options), indices, funds, performance metrics, operating results, financial positions, financing events, takeovers, mergers, acquisitions, business conditions, business decisions, forecasts or the like. The rates at which units of compensation may be traded for one and other may be affected by supply and demand for the units. The rates at which units of compensation may be traded for one and other may be affected by a board of directors or the like. The rates at which units of compensation may be traded for one another may change at the margin according to a formula. Trading may occur continuously or at set intervals. Trading may occur in a market or the like. Trading may be presented as or take the appearance of a game.

In embodiments, insiders 102 may structure their compensation by selecting from palates of compensation possibilities. The compensation selection may be broad, such as selecting between variable compensation and fixed compensation, or it may be specific, such as selecting the manner in which compensation is affected by a certain parameter, like earnings per share. The compensation possibilities and/or rules of compensation selection may be affected by one or more parameters (such as price, volatility, volume, timing, or an analyst expectation) related to one or more securities, commodities, currencies, derivative claims (including futures and options), indices, funds, performance metrics, operating results, financial positions, financing events, takeovers, mergers, acquisitions, business conditions, business decisions, forecasts or the like. The compensation possibilities and/or rules of compensation selection may be affected by the supply of and demand for certain compensation possibilities. The compensation possibilities and/or rules of compensation selection may be set by a board of directors or the like. The compensation possibilities and/or rules of compensation selection may change at the margin. Compensation selection may occur continuously or at set intervals. Compensation selection may occur in a market or the like. Compensation selection may be presented as or take the appearance of a game.

In embodiments, insiders 102 may be allowed to place wagers related to one or more securities, commodities, currencies, derivative claims (including futures and options), indices, funds, performance metrics, operating results, financial positions, financing events, takeovers, mergers, acquisitions, business conditions, business decisions, forecasts or the like. The wagers may be placed in a market or the like. The wagers may be in dollars or other monetary consideration and/or points or other non-monetary consideration. Wagering may occur continuously or at set intervals. The rules of wagering, including the odds and potential payouts, may be affected by one or more parameters (such as price, volatility, volume, timing, or an analyst expectation) related to one or more securities, commodities, currencies, derivative claims (including futures and options), indices, funds, performance metrics, operating results, financial positions, financing events, takeovers, mergers, acquisitions, business conditions, business decisions, forecasts or the like. The rules of wagering, including the odds and potential payouts, may be affected by the volume and direction of wagers. The rules of wagering, including the odds and potential payouts, may be set by a board of directors or the like. For example, in a particular embodiment, an insider 102 may be allowed to wager part of his annual bonus on whether annual earnings per share will reach a specified target level, with the potential payout increasing as the target level increases. Wagering may be presented as or take the appearance of a game.

In embodiments, insiders 102 may make predictions or give signals (or act in ways that function as predictions or signals) about one or more securities, commodities, currencies, derivative claims (including futures and options), indices, funds, performance metrics, operating results, financial positions, financing events, takeovers, mergers, acquisitions, business conditions, business decisions, forecasts or the like. The predictions or signals may take the form of words, numbers, sounds, game-play, visual displays or the like. The predictions or signals may be at fixed intervals or on a continuous basis. In one embodiment, an insider 102 may make predictions or signals without directly and/or immediately modifying his compensation. For example, the insider may demonstrate his ability to accurately predict future share prices without being directly compensated for his predictions; rather, the demonstrated accuracy of his predictions may allow him to negotiate greater compensation in a future employment contract. In this way, through his predictions he is indirectly modifying his future compensation and contributing to his human capital. In one embodiment, insiders 102 may be compensated for making predictions or giving signals, for the speed or accuracy of those predictions or signals, for other criteria related to the predictions or signals, and/or for participating in a broader arrangement that allows for such predictions or signals.

The systems and methods described herein may be implemented using a computer or computing device, website, network, portal, the Internet, software, rules, regulations, policies, contracts or by other means. The systems and methods described herein may be implemented using paper records. The systems and methods described herein may be implemented by a business, non-profit organization, corporation, bank, insurer, trust company, investment company, treasury, brokerage house, association of securities brokers or dealers, hedge fund, stock exchange, regulatory agency, government body, external service provider, including, but not limited to a consulting firm, or the like. Human participants may include directors, officers, executives, employees, contractors, consultants, advisors, lawyers, bankers, brokers, dealers, specialists, analysts (including those at credit bureaus and rating agencies), investors, creditors, government officials, researchers, members of the media, regulators, such as at the Securities and Exchange Commission, National Association of Securities Dealers, state securities commissions and the Federal Reserve Board, members of securities exchanges and automatic quotation systems, such as the NASDAQ, NYSE and AMEX, employees or volunteers at non-profit organizations, market participants, shareholder plaintiff bar, corporate defense bar, treasurers, and the like.

Insiders 102 may interact with a FAIR facility 108 through a user interface. The interaction may be via an electronic device, such as a computer, laptop computer, tablet PC, cell phone, telephone, personal digital assistant, personal email device, mobile device, Blackberry, Treo, pager, personal video game system, and the like. The device may include a display. The device may be an input device. The device may be an output device. The device may allow insiders 102 to interact with a FAIR facility 108 through the World Wide Web or by other means. The device may use passwords or other security features to identify each user. The device may allow insiders 102 to interact with a FAIR facility 108 on a continuous basis or only at set intervals. The device may allow insiders 102 to interact with interested parties 104 and/or with other insiders 102. The device may allow insiders 102 to receive and transmit information including information exclusive to insiders, without requiring direct disclosure of the inside information itself. The device may allow insiders 102 to individualize the information they send and/or receive or the manner in which they receive it, including the manner in which it is displayed. The device may provide insiders 102 with streaming “real time” news and/or data. The device may alert insiders 102 upon the occurrence of certain events, such as when a parameter related to a security reaches a specified level, when new business information becomes available, and the like. The systems and/or methods may involve linking to insider's 102 bank accounts, brokerage accounts, trading accounts, credit cards, online payment accounts (such as PayPal) and the like. Insiders 102 or their employers may be charged fees for using the device or for accessing a FAIR facility 108 or for services related to the device or the FAIR facility 108. In one embodiment, the FAIR facility 108 includes a web server that supports insider 102 interactions using a conventional web browser client.

Interested parties 104 may receive communications and/or analysis from the methods and systems described herein, including the FAIR facility 108, through a user interface. The user interface may be a computer user interface. The user interface may include an electronic device, such as a computer, laptop computer, tablet PC, cell phone, telephone, personal digital assistant, personal email device, mobile device, Blackberry, Treo, pager, personal video game system, and the like. The device may include a display. The device may be an input device. The device may be an output device. The device may provide users with streaming “real time” news and/or data. The device may alert users when new communications and/or analysis become available or upon the occurrence of other events. The device may allow users to interact with the FAIR facility 108 through the World Wide Web or by other means. The device may use passwords or other security features to identify users. The device may allow users to individualize the communications and/or analysis they receive and/or customize the manner in which they receive it, including the manner in which it is displayed. Users may be charged fees for using the device or for accessing a FAIR facility 108 or for services related to the device or the FAIR facility 108. The fees may defer the cost of implementing the systems and/or methods or may be profits to certain of the parties involved, such as insiders 102, service providers, companies that are the subject of the information, and the like. Interested parties 104 may receive communications and/or analysis from the methods and systems described herein, including the FAIR facility 108, through paper based reports and press releases. Recipients of paper reports and/or press releases may be charged a fee for the receipt of those reports and/or press releases. The fees may defer the cost of implementing the systems and methods or may be profits to certain of the parties involved, such as insiders 102, service providers, companies that are the subject of the information, and the like. In one embodiment, the FAIR facility includes a web server that supports interactions with interested parties using a conventional web browser client.

The FAIR facility 108 may be adapted to support a number of revenue models. For example, the communications and/or analysis archived by the FAIR facility may be compiled into a database. Recipients of communications and/or analysis may be charged fees for access to the database or any data therein. The fees may defer the cost of implementing the systems and methods or may be profits to certain of the parties involved, such as insiders 102, service providers, companies that are the subject of the communications and/or analysis, and the like. In addition, various service levels may be provided covering aspects such as use of analytic engines, real time (versus delayed) access to data, and degrees of access to data (e.g., full access versus summary or profile data access).

An advertising model may be employed. The user interface and/or the database itself may contain advertising and fees may be charged for such advertising space. As a significant advantage, an advertising model may employ the FAIR context (e.g., an equities trader interested in a particular company or industry) to target advertising to an appropriate audience.

The methods and/or systems described herein, including the FAIR facility 108, may be used to analyze, regulate and/or improve the flows of information within an organization. In an embodiment, employees at multiple levels of a company may be allowed to utilize a FAIR facility 108. The communications to interested parties 104 may include the types and/or levels of employees involved in the disclosure. This may allow market participants to evaluate the credibility of the purported information contained in the communications. For example, at a drug company, a junior scientist may first discover an adverse effect of a drug currently being produced and sold by the drug company, or a drug currently undergoing FDA trials or the like. The communications may show sales of phantom securities by the junior scientist, and then his boss, and then other scientists in his group, and then as information makes its way to senior management, senior management may then sell phantom shares. The market could use the pattern of communications to assess the source and significance of the underlying information contained in the FAIR trading patterns. For example, if the communications had originated with senior management or the marketing department, the purported information may be less credible. Permitting participation at various levels of a company may allow for more rapid dissemination of information both within the market and within companies. The market may be able to piece together information from various compensation modifications and/or other communications before top management has a handle on the issues. Management could get a handle on issues more quickly by tracking the compensation modifications and/or other communications. For example, if employees of a particular business unit began trading heavily in phantom securities, one of the company's key decision-makers may wish to meet with those employees to discuss their information. Management could also use the communication patterns to better structure the internal organization of a company. For example, if a business unit proved to be a consistent source of information, management may wish to bring that business unit in closer physical or hierarchical proximity to the company's key decision-makers.

The methods and/or systems described herein, including the FAIR facility 108, may be used for research, such as to study the effects of inside information or to study the flow of information within a company.

Use of a FAIR facility 108, such as for efficient dissemination of corporate information may have many beneficial effects. A FAIR facility 108 may narrow the distribution of potential returns by accelerating the resolution of uncertainty. Insiders 102 sometimes apprehend information before it is fully reflected in securities prices. Because investors and creditors make more accurate guesses about a corporation's stream of future cash flows when they have more information about that corporation, and because the deviation of a security's returns decreases as the accuracy of those guesses increases, a FAIR facility 108 may decrease the standard deviation of a security's returns. Most investors and creditors dislike risk. Such investors and creditors demand a premium over the risk-free rate of return that increases with the standard deviation of a security's returns. Therefore, a FAIR facility 108 may reduce a security's risk premium, which would increase the security's value.

A FAIR facility 108 may also allow security holders to recover resources that are currently wasted on redundant search. Today, industry analysts spend time and money to learn information that is already known by a firm's insiders 102. These search expenditures allow industry analysts to win trading transfers from those less informed security holders who happen to trade against them. A FAIR facility 108 may reduce the incentive for redundant searching by reducing the amount of information not yet reflected in a security's price. A reduction in redundant search may increase uninformed investors' and creditors' wealth by the accompanying reduction in trading transfers and produce a net social gain equal to the reduction in redundant search. The following example illustrates this point. A research analyst covering Personal Computer Inc. (“PC”) for a hedge fund surveys various computer wholesalers and analyzes the resultant data at a total cost of $100,000. Using this analysis, the analyst determines that PC's Q1 revenues will far exceed the consensus expectation—a fact already known to some of PC's insiders 102. On the basis of that determination, the analyst's firm buys 100,000 shares of PC at an average price of $25/share. PC's unexpectedly strong revenues are announced, causing the price of a share in PC to rise to $28. Over the next few days, the analyst's firm sells its shares at an average price of $28, netting $300,000 on the trade. The hedge fund's gain per force implies a $300,000 loss for other shareholders (since other shareholders would have to have held those 100,000 shares had the hedge fund not). Had news of the strong revenues been integrated into the price of shares before the analyst could act on it, such as may occur after the implementation of a FAIR facility 108, the hedge fund would not have gained $300,000, other shareholders would not have lost $300,000, and the hedge fund would not have spent $100,000 trying to divine PC's Q1 revenues. The elimination of those redundant search costs would create a net gain.

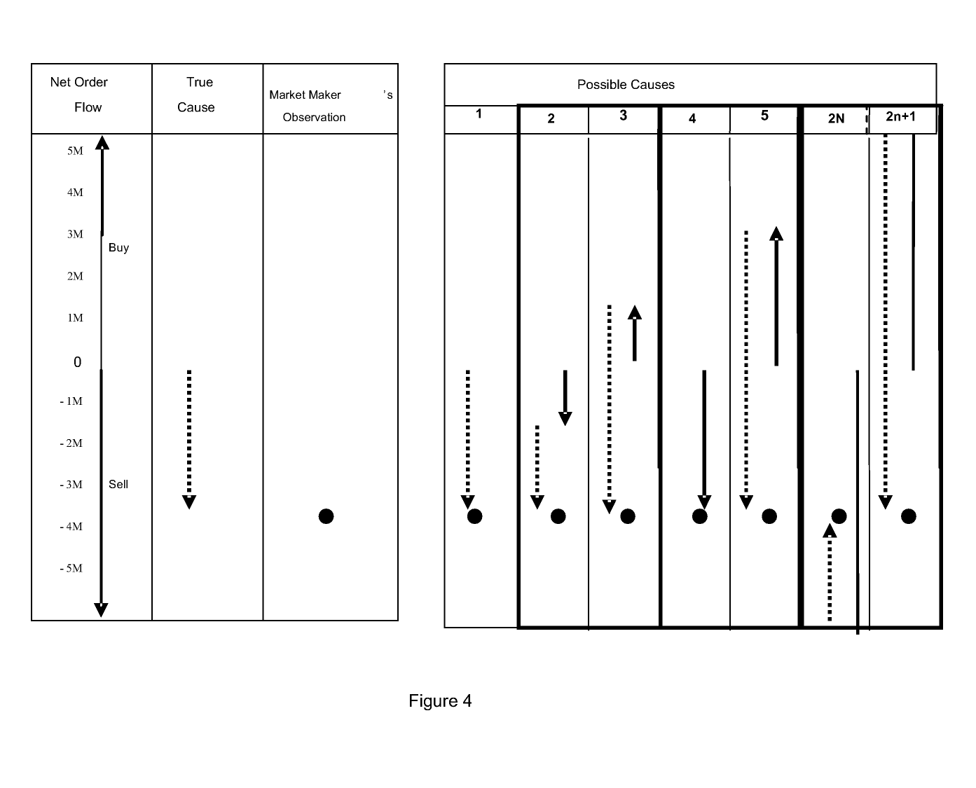

A FAIR facility 108 may increase liquidity by dampening excess volatility. When setting prices, market makers may infer knowledge from the flow of orders: an abnormally large inflow of net buy (sell) orders may cue market makers to raise (lower) prices. Unfortunately, such inferences are imperfect, for the order flow is shaped by both informed trades (hedge funds initiating or terminating bets on a stock, acquaintances of insiders exploiting illicit information, etc.) and uninformed trades (an institution or wealthy individual seeking liquidity, a coincidental influx of many small buy or sell orders, etc.). Accordingly, a large inflow of net buy (sell) orders may be the effect of a positive (negative) movement in the real value of the stock or of a deviation in the stochastic flow of uninformed buy (sell) orders. The problem is that since market makers cannot differentiate orders sent by informed traders from orders sent by uninformed traders, market makers will rationally respond to buy (sell) orders from uninformed traders by raising (lowering) the ask (bid). Such protective action by market makers may reduce the liquidity available to uninformed traders looking to raise or invest cash, since they will have to either accept higher (lower) asks (bids) or buy (sell) their shares piecemeal over time to stay under market makers' radar (and in so doing, accept the risk of price fluctuations). A FAIR facility 108 may reduce the number of orders received by market makers that are based on information not yet reflected in the price of shares. Such a reduction of informed orders could reduce the extent to which market makers respond to uninformed orders with liquidity-reducing adjustments to the bid and ask. FIG. 4 illustrates these concepts in greater detail.

Referring to FIG. 4, solely uninformed trades create an inflow of net sell orders (the magnitude of which is measured against the vertical axis found in the first column, where net buys are represented as positive numbers and net sales as negative numbers). A market maker receiving these orders likely has no way of knowing with certainty whether they contain information about the true value of shares. The market maker may only attempt to infer the informational content of the order flow through induction: specifically, by calculating the probability of each combination of informed and uninformed order components, given the observed aggregate order flow. In the figure, each solid arrow represents a (possible) informed order-flow component of the observed net order flow; each dashed arrow represents a (possible) uninformed order-flow component of the observed net order flow. The true cause is therefore naught but a dashed arrow. Each possible cause of the market maker's observation, except for the first, is paired with a second possible cause that has an informed component of the same size but opposite direction. In FIG. 4, such pairs are separated by a heavy black line. In every pair the likelihood of the even numbered component having been the cause of the observation is greater than the likelihood of the odd numbered component having been the cause, since the probability of the informed component in each pair is the same but the probability of the uninformed component is greater for the even numbered component, since the probability of a deviation (from zero) in the flow of uninformed orders decreases as the magnitude of that deviation increases. As such, the expected value of the informed component of the market maker's observation is negative. Thus, the market maker should infer that the observation was caused, at least in part, by net sales from informed traders. This inference suggests to market makers that they are bidding more for shares than those shares are actually worth and, consequently, cues them to adjust their bids downward. A FAIR facility 108 may mitigate these issues.

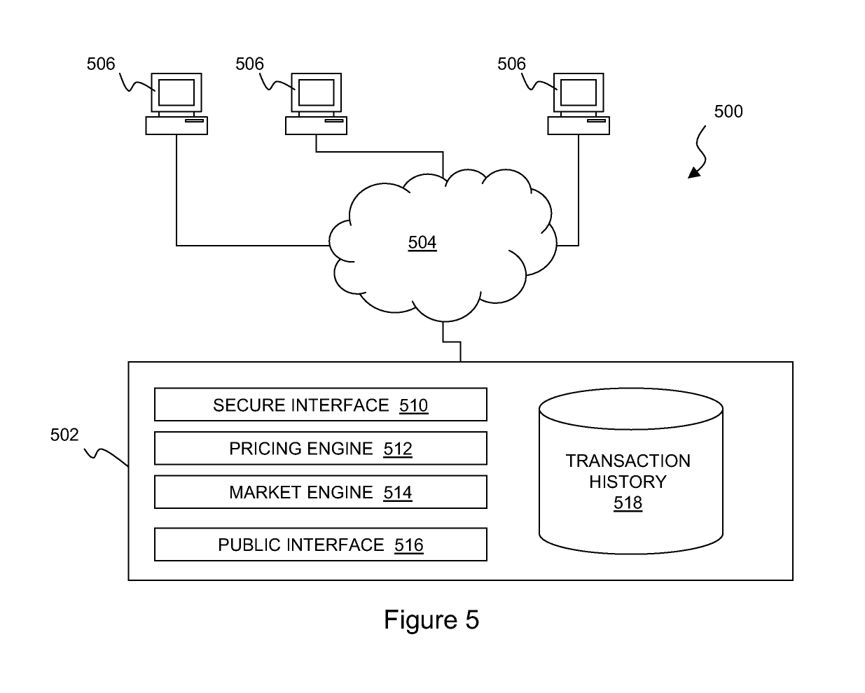

FIG. 5 depicts an embodiment of a FAIR facility system 500. The system 500 may include a FAIR facility 502, a network 504, and one or more clients. The FAIR facility 502 may include a secure interface 510, a pricing engine 512, a market engine 514, a public interface 516, and a transaction history database 518. The system 500 is now described in greater detail.

The FAIR facility 502 generally operates to support the functions and features described above. This may include, for example, receiving information or trade requests from insiders, processing trades, providing public access to trading data, and maintaining a record of trades and other informational transactions.

The network 504, which may include various public and private networks such as the Internet, wireless networks, cellular phone networks, WiMax networks, satellite networks, the public switched telephone network, and so forth, serves to interconnect the FAIR facility 502 with various client devices 506.

The client devices 506 may include any device suitable for communicating with the FAIR facility 502 including without limitation cellular phones, telephones, wireless e-mail devices, laptop or other portable computers, desktop computers, and so forth. Client devices 506 may include devices operated by secure users of the FAIR facility 502 as well as devices operated by general users of the FAIR facility 502 public interface. The client devices 506 may also include computerized systems such as stock price reporting systems or any other sources of public data that might provide data to the FAIR facility 502 for purposes of pricing within the FAIR market.

The secure interface 510 may provide an interface to secure users (e.g., insiders and other FAIR market participants) of the system 500. This may be, for example, a secure socket layer web interface through which secure users provide login credentials to access the FAIR marketplace. This may also, or instead, include a dedicated private line or virtual private network interface to a corporate area network. In general, the secure interface 510 is accessed by employees, executives, and the like to provide information or request transactions within the FAIR environment.

The pricing engine 512 may implement any rules, algorithms, formulas, or the like to determine prices of phantom securities within the FAIR marketplace. This may include, for example, publicly available information about a company or a stock (or other financial instrument), as well as non-public information provide by a corporation using the FAIR facility 502.

The market engine 514 may provide a trading platform for phantom securities or the like within the FAIR marketplace. This may include any number of rules, formulae, or the like for clearing transactions either through conventional two-sided market making techniques, or by providing a set of predetermined rules for transactions between the corporation and individual participants. The market engine 514 may rely in whole or in part on pricing information provided by the pricing engine 512 for clearing transactions.

The public interface 516, which may be a web interface or the like, provides public access to some or all of the data on the FAIR market place.

A transaction history 518 may be maintained for some or all of the transactions conducted within the FAIR marketplace. This information may be searchable in its raw form, or may be available to certain users (such as the general public through the public interface 516) only in summary or abstract form.

It will be appreciated that the above systems and methods may be realized in hardware, software, or any combination of these suitable for supporting a FAIR system described herein. This includes realization in one or more microprocessors, microcontrollers, embedded microcontrollers, programmable digital signal processors or other programmable devices, along with internal and/or external memory. The may also, or instead, include one or more application specific integrated circuits, programmable gate arrays, programmable array logic components, or any other device or devices that may be configured to process electronic signals. It will further be appreciated that a realization may include computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. At the same time, processing may be distributed across devices such as a database, web server, and client devices in a number of ways or all of the functionality may be integrated into a dedicated, standalone device, such as within a corporate area network. All such permutations and combinations are intended to fall within the scope of the present disclosure.

While the invention has been described in connection with certain preferred embodiments, other embodiments may be understood by those of ordinary skill in the art and are encompassed herein. All document referenced herein are hereby incorporated by reference.

1. A method of revealing corporate information, comprising:
providing an insider with a FAIR facility that allows the insider to take at least one action selected from the group consisting of: trading, wagering, making predictions and selecting among compensation alternatives;
analyzing at least one of the actions and inactions of the insider; and
communicating at least one of the actions and inactions of the insider, as well as any analysis thereof, to at least one interested party.

2. The method of claim 1, wherein the at least one action is facilitated through a user interface.

3. The method of claim 1, wherein the at least one action is facilitated through the use of at least one of a computer, electronic device, network and software.

4. The method of claim 1, wherein the action affects the human capital of the insider.

5. The method of claim 1, wherein the method is implemented using at least one of policies, rules, regulations and contracts.

6. A method of revealing corporate information, comprising:
providing a FAIR facility to an insider;
analyzing the behavior of the insider; and
communicating the behavior of the insider, as well as any analysis thereof, to at least one interested party.

7. The method of claim 6, wherein the FAIR facility includes a user interface.

8. The method of claim 6, wherein the method is facilitated through the use of at least one of a computer, electronic device, network and software.

9. The method of claim 6, wherein the communication is facilitated by the FAIR facility.

10. The method of claim 6, wherein the method is implemented using at least one of policies, rules, regulations and contracts.

11. The method of claim 6, wherein the behavior of the insider affects his compensation.

12. The method of claim 6, wherein the behavior of the insider affects his reputation.

13. A system for communicating corporate information to the public comprising:
a market engine supporting trades in at least one synthetic security, the synthetic security having a price related to at least one item of public information for a company;
a secure interface for authenticated access to the system;
a database storing a plurality of trades executed by the market engine according to trade orders received through the secure interface; and
a public interface for un-authenticated access to information in the database.

14. The system of claim 13 wherein the at least one item of public information includes a price of a stock for the company.

15. The system of claim 14 wherein the price of the synthetic security equals the price of the stock for the company.

16. The system of claim 13 wherein the synthetic security has a price related to at least one item of non-public information for the company.

17. The system of claim 13 wherein the public interface supports access to the plurality of trades.

18. The system of claim 13 wherein the public interface supports access to summary data for the plurality of trades.

19. The system of claim 13 wherein access to data for a particular trade is delayed a predetermined amount.

20. The system of claim 19 wherein the predetermined amount is determined according to a fee-based service level of a user.

21. The system of claim 13 wherein the secure interface includes a virtual private network.

22. The system of claim 13 wherein the public interface includes a web interface.

23. The system of claim 13 further comprising a pricing engine that calculates a price of the synthetic security.

24. The system of claim 13 wherein the market engine supports trades between company employees.

25. The system of claim 13 wherein the market engine supports trades in a plurality of synthetic securities, each one of the plurality of synthetic securities having a price related to one or more metrics of the company.

26. The system of claim 25 wherein an executive of the company has a compensation based on holdings of various ones of the plurality of synthetic securities.

27. The system of claim 26 further comprising a compensation calculation engine that determines a compensation of the executive based on holdings of the synthetic securities.

28. The system of claim 13 wherein the market engine provides a company-supported market for the synthetic security to enable unilateral trades in the synthetic security by a member of the company.

29. The system of claim 13 wherein the market engine limits trades by a user.

30. The system of claim 29 wherein the user is limited to a predetermined volume of trades within a predetermined time.
